(19) United States
(12) Patent Application Publication
(10) Pub. No.: US 2012/0263014 A1
(43) Pub. Date: Oct. 18, 2012

(54) DEVICE FOR HOMOGENIZING LIQUID MANURE IN A CESSPOOL

(76) Inventor: Uwe Von Briel, Bad Arolsen (DE)

(21) Appl. No.: 13/475,807

(22) Filed: May 18, 2012

Related U.S. Application Data
(63) Continuation of application No. PCT/DE2010/001287, filed on Nov. 4, 2010.

(30) Foreign Application Priority Data
Nov. 25, 2009 (DE) 102009055773.3

(51) Int. Cl. B01F 7/24

(52) U.S. Cl. 366/261

(57) ABSTRACT

Example apparatus and methods for homogenizing liquid manure in a cesspool are disclosed. One example device includes a pontoon to float in or on the liquid manure and a stirring unit held on the pontoon and to be immersed in the liquid manure. The example stirring unit includes a first stirring screw to rotate around a first rotational axis and a second stirring screw to rotate around a second rotational axis. The example first and second stirring screws are oriented such that the first rotational and the second rotational axis are substantially orthogonal to a direction of motion of the pontoon.

### RELATED APPLICATIONS

This patent is a continuation of International Patent Application Serial No. PCT/DE2010/001287, filed Nov. 4, 2010, which claims priority to German Patent Application No. 10 2009 055 773.3, filed on Nov. 25, 2009, both of which are hereby incorporated herein by reference in their entireties.

### FIELD OF THE DISCLOSURE

The present disclosure relates to a device for homogenizing liquid manure in a cesspool.

### BACKGROUND

The liquid manure accruing in a farm is collected in a cesspool and is stored there for further use. If required, the liquid manure in this cesspool can also be processed. Thereby, individual constituents of the liquid manure can settle at the bottom due to gravity and other buoyant parts can ascend and accumulate at the surface. In order to further use the liquid manure, more specifically for spreading it on the fields, it would be preferable to have homogeneous liquid manure available.

A device for preparation of the liquid manure by means of which the liquid manure is oxygenated is known from German Patent DE 43 19 864 A1. This device comprises a propeller immersed in the liquid manure, with which the entire device is moved inside the cesspool. Thereby, oxygen is introduced into the liquid manure by way of a special oxygen supply device and is dispersed by way of the propeller and added to the liquid manure. A partial homogenization of the liquid manure also occurs at the same time.

### BRIEF DESCRIPTION OF THE DRAWINGS

FIG. 1 shows a plan view of an example device according to the teachings of the present disclosure.

FIG. 2 shows a perspective view of the device according to FIG. 1.

### DETAILED DESCRIPTION

Disclosed herein are example methods and apparatus for homogenizing liquid manure in a cesspool. One object of the present disclosure is to create a device and a method, which homogenizes the liquid manure to a high degree in a cost-effective manner. As a technical solution to this object, the present disclosure proposes a device as disclosed and claimed herein.

For example, one example device for homogenizing liquid manure in a cesspool includes a pontoon to float in or on the liquid manure and a stirring unit held on the pontoon and to be immersed in the liquid manure. The example stirring unit includes a first stirring screw to rotate around a first rotational axis and a second stirring screw to rotate around a second rotational axis. The example first and second stirring screws are oriented such that the first rotational and the second rotational axis are substantially orthogonal to a direction of motion of the pontoon.

In some examples, the first and second stirring screws are disposed in opposite directions and/or the first and second rotational axes are substantially oriented horizontally and/or are aligned with each other. In some examples, the first and second stirring screws are adjustable in height and/or at least one stirring screw is rotatable around a vertical axis.

In some examples, the device includes a guide to guide the pontoon in its direction of motion. The example guide may be a steel cable to be anchored in a fixed place. Also, the example guide may include synchronized first and second driving winches, the first driving winch to pull the pontoon, the second driving winch to unroll. In some examples, the second driving winch also is to pull the pontoon, and the first driving winch also is to unroll.

An example method for homogenizing liquid manure in a cesspool disclosed herein includes using a stirring unit attached to a floating pontoon and moving stirring screws, having a rotational axis, through the liquid manure orthogonally to the rotational axis.

A device designed according to the technical teachings of this disclosure and a method implemented according to the technical teachings of this disclosure have the advantage that the stirring screws move the liquid manure transversely to the direction of motion of the pontoon, the consequence being that the stream of liquid manure generated by the stirring screw spreads to the right and the left of the pontoon and causes a good homogenization of the liquid manure. Due to the suction effect, the liquid manure is thereby drawn in from the area of the pontoon and also from layers below the pontoon.

Thus, not only is the area directly at and below the pontoon homogenized at each passage of the pontoon through the cesspool, but also a broad strip at the right and at the left of the pontoon. This results in a much faster and more thorough homogenization of the liquid manure in the cesspool.

In an example embodiment, the stirring screws are disposed in opposing directions. This is advantageous in that one stirring screw transports the liquid manure toward the right in the direction of travel and the other transports the liquid manure toward the left. The space to the right and left of the pontoon is thus used for stirring, which contributes to an increased homogeneity.

Another advantage is that due to the arrangement in opposite directions, the propeller walk of the stirring screw is compensated for, so that the forces affecting the guidance of the pontoon are minimized.

In another example, the rotation axes are substantially aligned horizontally. This has the advantage that the liquid manure moved by the stirring screws is moved as far as possible into the space of the cesspool in order to achieve a good homogenization.

In some examples, the stirring units are held on the pontoon so as to be adjustable in height. Hereby, it is possible to implement the homogenization of the liquid manure at different levels in the cesspool, which leads to a further improvement of the homogenization.

In some examples, the stirring screws are disposed in such a manner that their rotational axes are aligned with each other. This has the advantage that the forces acting on the pontoon due to the stirring unit are located at the same level and cancel each other out. The forces acting on the pontoon and on the guidance of the pontoon are thus minimized.

In another example, the pontoon is guided in its direction of motion by a guide. It is hereby possible to move the pontoon in a directed manner along a predetermined course through the cesspool. Thereby, it is sufficient that this guide be disposed substantially in the center of the cesspool since, due to the orthogonal arrangement of the stirring screws, the liquid manure is moved far into the pool and thus homogenized.

In another example, a stirring screw is swivel-mounted on a vertical axis. Thereby, it is sufficient if the stirring screw is rotatable by only a few angular degrees, for instance up to about 15°. Not only transverse forces but also a force component in the direction of motion thus acts on the pontoon, the consequence being that the pontoon can be moved forward by way of the stirring screws.

Further advantages of the device according to the examples disclosure herein and of the method according to the disclosure are shown in the attached drawing and the embodiments described in the following. According to the examples disclosed herein, the afore-mentioned and further developed features can also be used respectively individually or in any combination of each other. The mentioned embodiments are not an exhaustive enumeration but must rather be understood as mere examples.

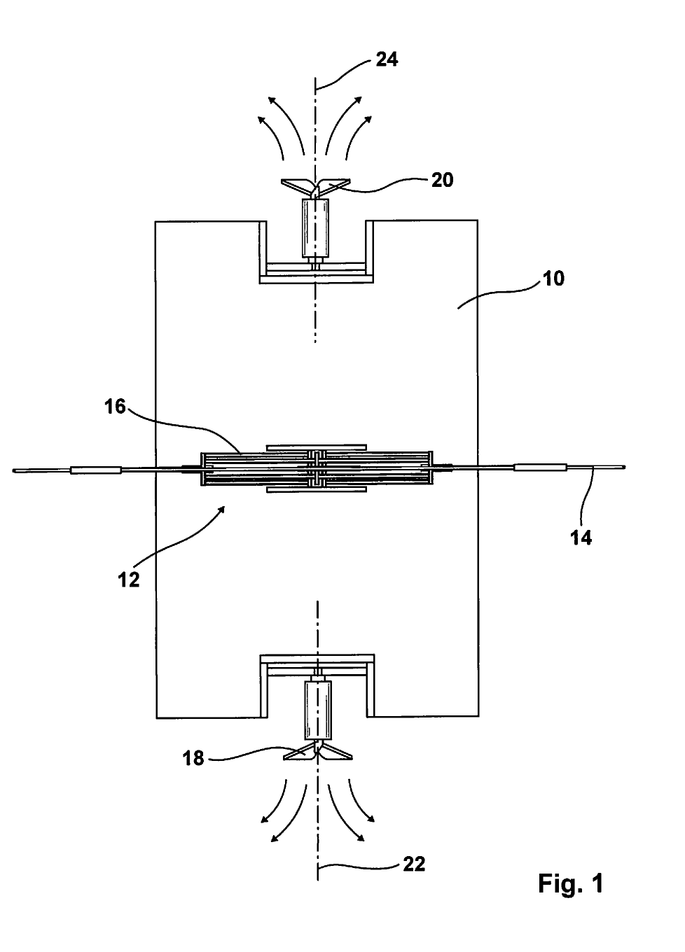

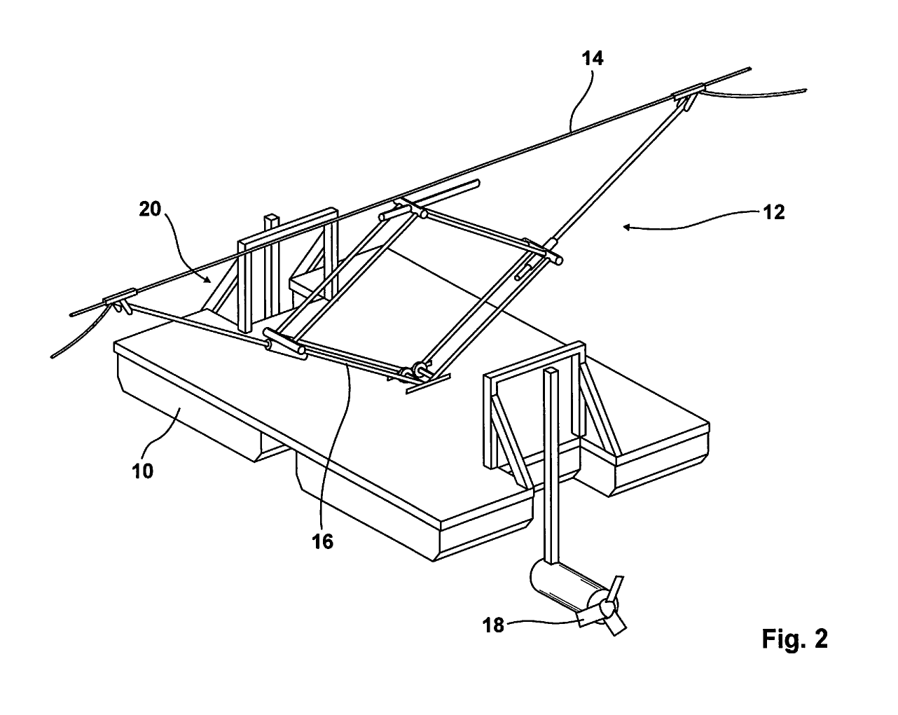

Turning to the figures, the device for homogenizing liquid manure in a cesspool shown in FIGS. 1 and 2 comprises a pontoon 10 floating freely on the liquid manure, which is movable forward and backward by way of a guide 12. The guide 12 includes a steel cable 14, which is held to the rim of the pool. The guide 12 furthermore comprises a scissor-type linkage 16 in order to compensate for the height difference between the steel cable 14 and the pontoon 10 at different fill levels of the cesspool. The steel cable 14 is rolled up at each end onto respectively one winding roll not shown here, wherein in order to move the pontoon 10, a roll rolls-up the steel cable 14, while the other unrolls the corresponding steel cable 14.

A stirring unit with two stirring screws 18, 20 is attached to the pontoon 10 in such a manner that the stirring screws 18, 20 are completely immersed in the liquid manure. The stirring screws 18, 20 thereby rotate around respectively one rotational axis 22, 24, the rotational axes 22, 24 being disposed so as to be aligned with each other and being oriented orthogonally to the direction of motion of the pontoon 10. The rotational axes 22, 24 are furthermore configured substantially horizontally.

The stirring screws 18, 20 are disposed in opposite directions, so that the liquid manure moved by the stirring screw 18 is conveyed in an opposite direction relative to the liquid manure moved by the stirring screw 20.

In another embodiment, the pontoon is moved by way of a drive installed on the pontoon. This electric drive drives one or more friction wheels which act on the guidance cable and move the pontoon back and forth along the guidance cable.

In another embodiment, the stirring units are adjustable in height so that the stirring screws 18, 20 can plunge to different depths in the liquid manure and thus homogenize the liquid manure at a large variety of levels.

In yet another embodiment, the stirring screws are rotatable around a vertical axis by up to 15°, preferably up to 10°. A force is hereby exerted on the pontoon, which moves the entire device forward. The bigger the angle of attack, the faster the drive.

In order to homogenize liquid manure in a cesspool, the pontoon 10 is attached, by way of a scissor-type linkage 16, to a steel cable 14, which is fastened in a fixed place at the edge of the cesspool. Thereby, the electrically driven stirring screws 18, 20 are disposed in such a manner that the liquid manure is transported orthogonally to the direction of motion of the pontoon 10. During motion of the pontoon 10 a very big part of the cesspool is hereby covered by the stirring screws 18, 20, leading to a great homogenization of the liquid manure.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A device for homogenizing liquid manure in a cesspool, the device comprising:
a pontoon to float in or on the liquid manure; and
a stirring unit held on the pontoon and to be immersed in the liquid manure, wherein the stirring unit comprises a first stirring screw to rotate around a first rotational axis and a second stirring screw to rotate around a second rotational axis, wherein the first and second stirring screws are oriented such that the first rotational and the second rotational axis are substantially orthogonal to a direction of motion of the pontoon.

2. The device according to claim 1, wherein the first and second stirring screws are disposed in opposite directions.

3. The device according to claim 1, wherein the first and second rotational axes are substantially oriented horizontally.

4. The device according to claim 1, wherein the first and second stirring screws are adjustable in height.

5. The device according to claim 1, wherein the first and second rotational axes are aligned with each other.

6. The device according to claim 1 further comprising a guide to guide the pontoon in its direction of motion.

7. The device according to claim 6, wherein the guide comprises a steel cable to be anchored in a fixed place.

8. The device according to claim 6, wherein the guide comprises synchronized first and second driving winches, the first driving winch to pull the pontoon, the second driving winch to unroll.

9. The device according to claim 8, wherein the second driving winch also is to pull the pontoon, and the first driving winch also is to unroll.

10. The device according to claim 1, wherein at least one stirring screw is rotatable around a vertical axis.

11. A method for homogenizing liquid manure in a cesspool, the method comprising:
using a stirring unit attached to a floating pontoon; and
moving stirring screws, having a rotational axis, through the liquid manure orthogonally to the rotational axis.
